(19) United States
(12) Patent Application Publication
(10) Pub. No.: US 2004/0019780 A1
(43) Pub. Date: Jan. 29, 2004

(54) System, method and computer product for delivery and receipt of S/MIME encrypted data

(76) Inventors: Donald Waugh, Oakville (CA); Michael Roberts, Thornhill (CA); Viatcheslav Ivanov, Thornhill (CA)

Correspondence Address: MILLER THOMPSON, LLP, 20 QUEEN STREET WEST, SUITE 2500, TORONTO, ON, M5H 3S1, CA

(21) Appl. No.: 10/379,528

(22) Filed: Mar. 6, 2003

(30) Foreign Application Priority Data
Jul. 23, 2002 (CA) 2,394,451

(51) Int. Cl. H04L 9/00

(52) U.S. Cl. 713/152; 713/155; 713/176

(57) ABSTRACT

A system for encrypting and decrypting S/MIME messages using a browser in either a web or wireless device for transmission to or from a web server on the Internet connected to an email server. The S/MIME encryption and decryption is conducted using a standard web browser on a personal computer or a mini browser on a wireless device such that email transmitted to the web or wireless browser from the web server can be completed and encrypted and signed by the user of the browser with such encrypted and signed data can be sent back to the web server. A method for delivering and using private keys in a browser and to ensure that such keys are destroyed after use is also provided. A method of transmitting encrypted S/MIME compliant messages to a web or wireless browser and decrypting and verifying such messages using the browser on the wireless device is also disclosed. A method for authenticating the sender/user of the browser, and a method for verifying and retrieving the certificates of the intended recipient of such messages in accordance with the public key infrastructure.

### FIELD OF THE INVENTION

The invention relates generally to secure delivery and receipt of data in a public key infrastructure (PKI). This invention relates more particularly to secure delivery and receipt of S/MIME encrypted data (such as electronic mail) using web and WAP browsers connected to the Internet.

### BACKGROUND OF THE INVENTION

In the past 10 years, email (electronic mail) has taken on unparalleled use, as email has generally become an invaluable tool that enables parties to communicate work products quickly, easily, and efficiently. While email is very convenient, the security of data communicated using email is generally becoming an increasing concern as corporate correspondence moves from paper to digital form and hackers become more proficient at penetrating email systems. As 60% of a company's intellectual property can be found in digital form somewhere in its email message system (as some reports state), the need for secure email messaging is a valid concern, particularly in the case of sensitive business information.

In order to address this need for email security, S/MIME (Secure Multipurpose Internet Mail Extension) protocol was established by RSA Data Security and other software vendors approximately in 1995. The goal of S/MIME was to provide message integrity, authentication, non-repudiation and privacy of email messages through the use of PKI (Public Key Infrastructure) encryption and digital signature technologies. Email applications that support S/MIME are assured that third parties, such as network administrators and ISPs, cannot intercept, read or alter their messages. S/MIME functions primarily by building security on top of the common MIME protocol, which defines the manner in which an electronic message is organized, as well as the manner in which the electronic message is supported by most email applications.

Currently, the most popular version of S/MIME is V3 (version three), which was introduced in July, 1999. Further information on S/MIME standardization and related documents can be found on the Internet Mail Consortium web site (www.imc.org) and the IETF S/MIME working group (www.ietf.org/html.charters/smime-charter.html).

The S/MIME V3 Standard consists generally of the following protocols:

Cryptographic Message Syntax (RFC 2630)

S/MIME Version 3 Message Specification (RFC 2633)

S/MIME Version 3 Certificate Handling (RFC 2632)

Diffie-Hellman Key Agreement Method (RFC 2631)

Enhanced Security Services (RFC 2634) is another protocol for S/MIME, and is a set of extensions which allows signed receipts, security labels, and secure mailing lists. The extensions for signed receipts and security labels will work with either S/MIME V2 or S/MIME v3, whereas the extension for secure mailing lists will only work with S/MIME V3. S/MIME messages are exchanged between users by requiring that the email software prepare an S/MIME file in accordance with the S/MIME specifications. The S/MIME file is sent as an attachment to an email message. Once this message reaches the recipient, it can only be processed if the recipient possesses a comparable version of an S/MIME email reader.

There are a number of challenges in exchanging email messages with the current S/MIME standards, including the following. If the recipient does not have S/MIME software capabilities, then the S/MIME message cannot be accessed and will be stored unopened, on the recipient's computer. An S/MIME encrypted message can similarly not be read if either the sender or the recipient was not enrolled with a Certificate Authority. The same result would occur if there were incompatibility between the S/MIME versions used by the sender and the recipient. This is a particularly important problem in that the S/MIME standards contemplate a general scale update of the then current S/MIME version to a modified S/MIME version in the event of a detected security breach. S/MIME email exchange would also be hindered if there was incompatibility between the email software used by each of the sender or recipient. S/MIME encrypted email exchange would also effectively be prevented if the S/MIME compatible email software was corrupt or if the sender's or recipient's keys have expired.

In order to remedy many of these problems, recipients usually upgrade or obtain their S/MIME email reader to take advantage of the most recent standardized version of the S/MIME protocol. The difficulty with this solution is the fact that it requires the user to download relatively large additional software packages that require constant updating in addition to taking up system resources.

Deployment of S/MIME encryption for secure email messaging using browsers is one possible solution to the aforesaid problems. A number of prior art solutions employing web or WAP browser technology are known.

For example, Application No. WO00/42748, published on Jul. 20, 2000, inventors Dmitry Dolinsky and Jean-Christophe Bandini, assigned to Tumbleweed Communications Corp. (the “Tumbleweed” reference), discloses a prior solution for secure web based email which is stated to eliminate the need for the user and the recipient to download S/MIME software packages through the use of an intermediary host server, separate from the email software applications. In this solution, the intermediary host server intercepts emails sent by the sender and then passes a message on to the recipient's email account informing them that a secure email is waiting for them. This message also contains the link to the decrypted message located on the intermediary host server. The decrypted message is presented to the recipient in an SSL session.

This prior art solution has a number of disadvantages. Relatively speaking, the use of an intermediary host server generally complicates the secure transactions overall and increases the infrastructure costs of providing secure email messaging. Another disadvantage of the Tumbleweed technology is that because the sender's computer does not have cryptographic capability, the solution overall bears the relative risks associated with a relatively porous network environment. Also, the nature of the solution proposed in the Tumbleweed reference overall does not readily provide for deployment over wired and wireless networks.

What is needed therefore is a web-based system, computer product and method for communicating data (including emails) on a secure basis using S/MIME that is easy to deploy using web and WAP browsers. What is further needed is an aforesaid system, computer product and method that is easily deployed, and at a relatively low cost, in that the cryptographic resources required for S/MIME encrypted messaging is provided at the network-connected devices themselves. What is also needed is a web-based system, computer product and method whereby the S/MIME encryption persists throughout the communication of data.

### SUMMARY OF THE INVENTION

The system, computer product and method of the present invention enables users to access their email account on an email server and to create or read S/MIME messages through any browser without the need to install client based email software. From a software distribution and user support perspective this generally eliminates the need to support client based email thus reducing the cost of user and software support as well as addressing the need to support user mobility.

In another aspect of the present invention, users are enabled to remotely access private keys and digital certificates over the Internet from any network-connected device. This generally eliminates the need for location specific private key and digital certificate storage.

### BRIEF DESCRIPTION OF THE DRAWINGS

A detailed description of the preferred embodiment(s) is(are) provided herein below by way of example only and with reference to the following drawings, in which:

FIG. 1 is a schematic System Architectural Component Diagram of the S/MIME browser based email system.

FIG. 1a is a program resource chart illustrating the resources of the application of the present invention.

FIG. 2 is a flow chart which depicts the steps in receiving, verifying, and decrypting an S/MIME message from an email server for display in a browser.

FIG. 3 is a flow chart which depicts the steps for creating, signing and encrypting an S/MIME message in a browser for transmission to a web server to an email server.

FIG. 4 is a schematic illustration of the detailed steps involved with creating, signing, and encrypting an unencrypted message.

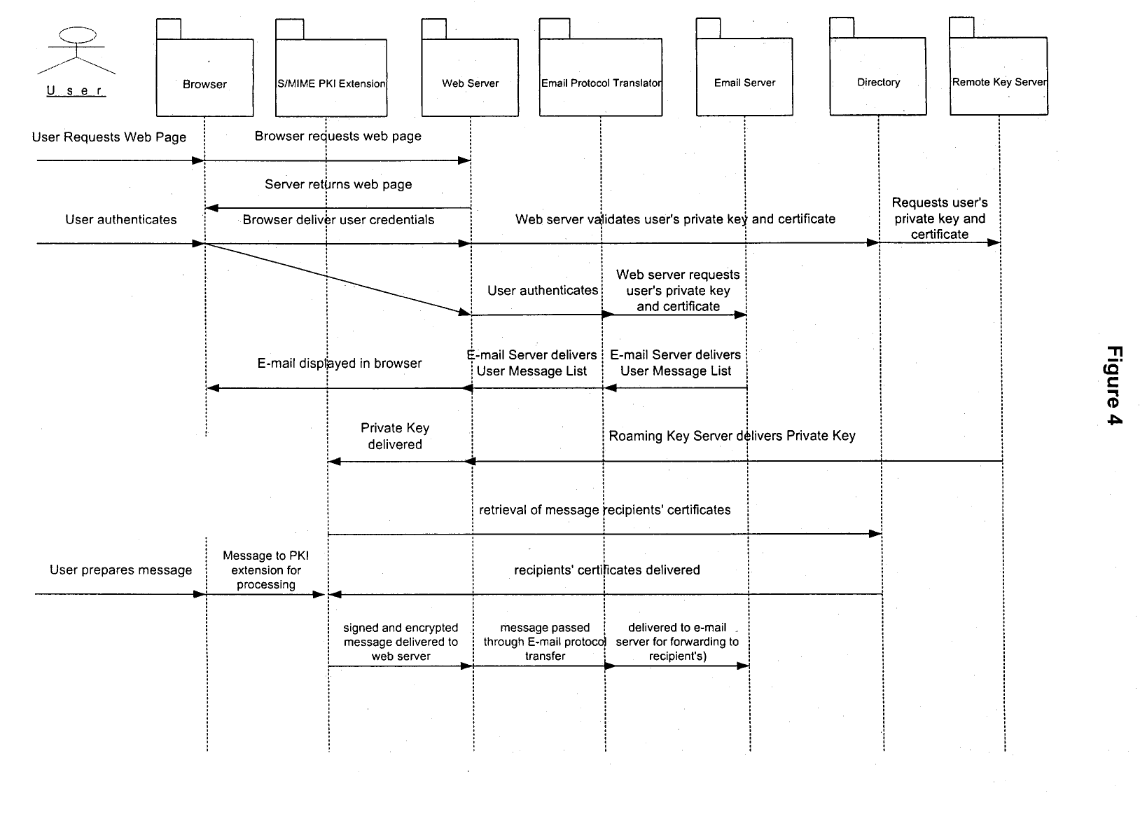

FIG. 5 is a schematic illustration of the detailed steps involved with retrieving and decrypting an encrypted message.

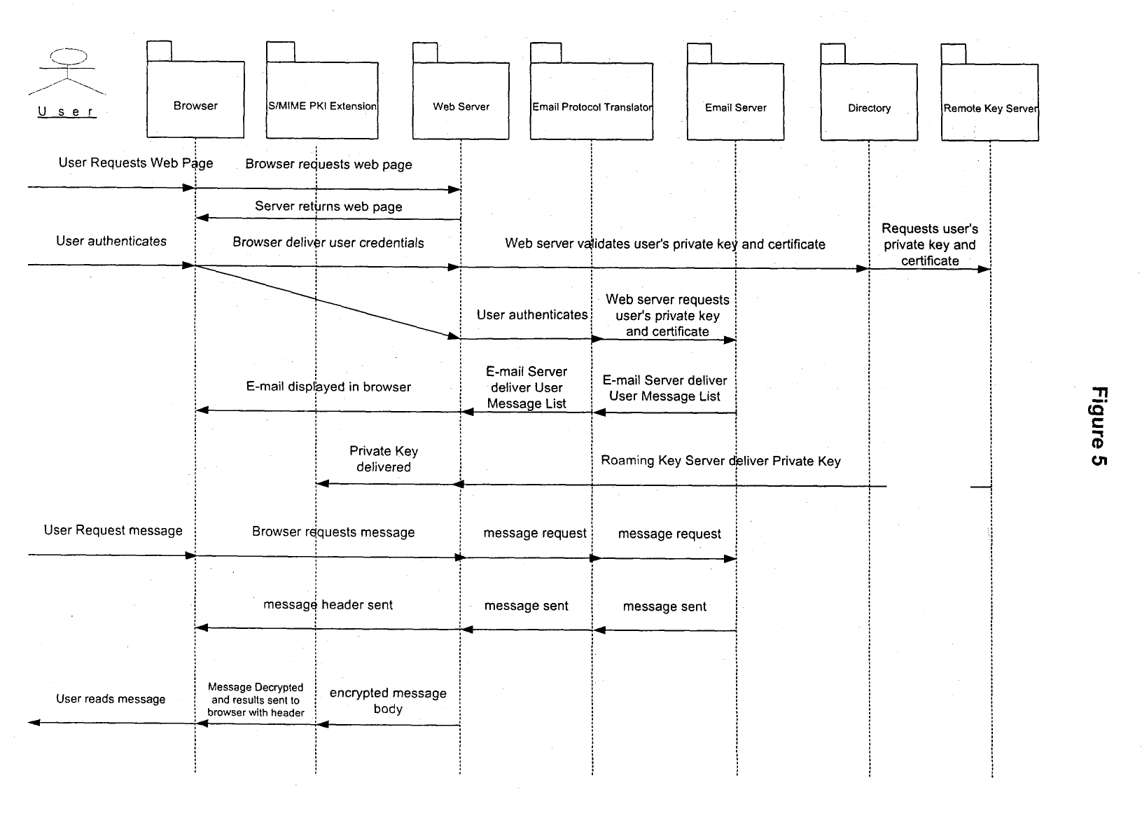

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

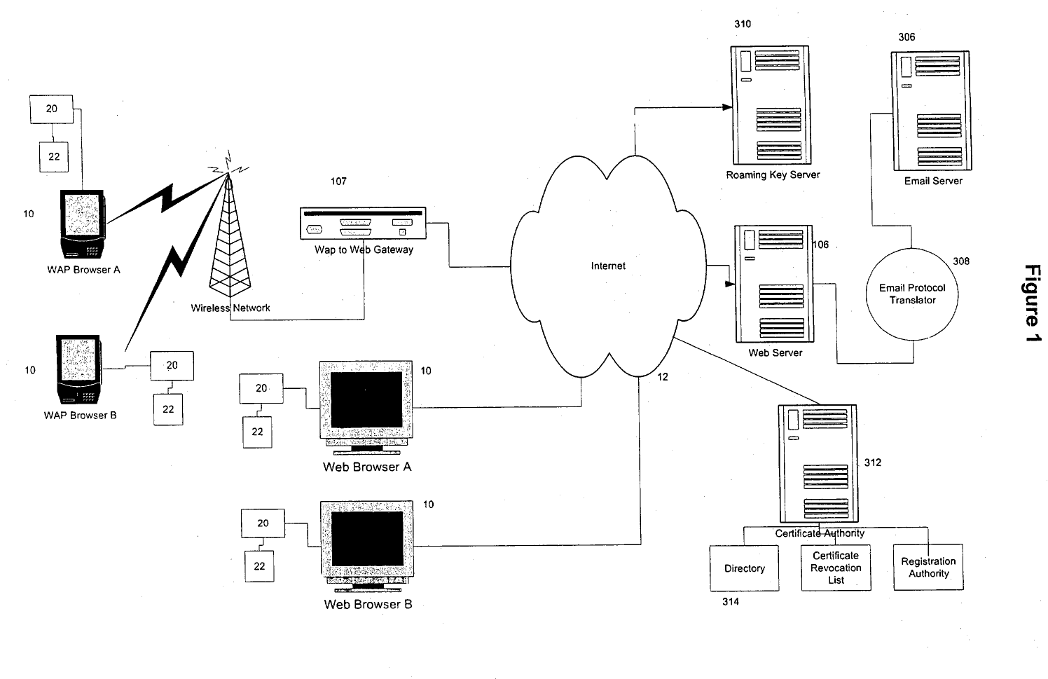

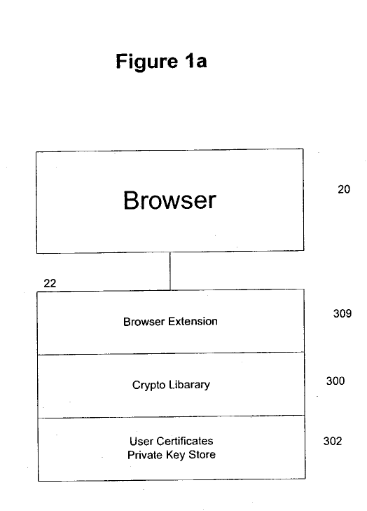

As illustrated in FIG. 1, at least one known network-connected device 10 is provided. Network-connected devices 10 may include a number of digital devices that provide connectivity to a network of computers. For example, network-connected device 10 may include a known personal computer or a known WAP device, cell phone, PDA or the like.

The network-connected device 10 is connected to the Internet 12 in a manner that is known. Specifically in relation to FIG. 1, the connection of a network-connected device 10 that is a known WAP device to the Internet is illustrated, whereby a known WAP to WEB gateway 107 is provided, in a manner that is also known.

Each of the network-connected devices 10 also includes a browser 20. The browser can be a standard Internet based browser, such as Netscape's Navigator™ or Microsoft's Internet Explorer™ or a known mini browser for wireless products such as cell phones or PDAs.

Each of the network-connected devices 10 also includes the application 22 of the present invention. The particulars of this application, and the manner in which it permits PKI enabled communications over wired and wireless networks is disclosed in the co-pending application U.S. application Ser. No. 10/178,224 (the “Co-Pending Application”),

In one particular embodiment of application 22, a browser extension or plug-in is provided in a manner that is known. Specifically, the application 22 and the browser 20 inter-operate by means of, for example, customized HTML tags. As opposed to using an intermediate host server, or a relatively large computer program, application 22 preferably provides necessary resources, as particularized below, to function with any third party PKI system, including for example, ENTRUST™, MICROSOFT™, BALTIMORE™, RSA™ and so forth. It should also be understood that the functions of the application 22 described herein can also be provided as an “ACTIVE X OBJECT” in a manner that is known, or integrated within a browser.

Each of the network-connected devices 10 also includes a browser 20. The browser can be a standard Internet based browser, such as Netscape's Navigator™ or Microsoft's Internet Explorer™ or a known mini browser for wireless products such as cell phones or PDAs.

Each of the network-connected devices 10 also includes the application 22 of the present invention. In one particular embodiment of the present invention, application 22 is best understood as a browser extension or plug-in that is provided in a manner that is known. Specifically, the application 22 and the browser 20 inter-operate by means of, for example, customized HTML tags.

It should also be understood, however, that the resources of the application 22 could also be provided by integration of the features of the application 22 in a browser or mini-browser, as opposed to a standalone application.

Application 22 preferably provides necessary resources, as particularized below, to function with any third party PKI system, including for example, ENTRUST™, MICROSOFT™, BALTIMORE™, RSA™ and so forth.

Application 22 includes a cryptographic utility 24, provided in a manner that is known, that is adapted to perform at network-connected device 10 a series of cryptographic operations, including but not limited to:

Digital signature of data in form fields;

Encryption of data in form fields;

Decryption of data in form fields;

Verification of signature of data in form fields;

Digital signature and encryption of data in form fields;

Verification of Digital signature and decryption of data in form fields;

Digital signature of full pages;

Verification of digital signature of full pages;

Encryption of full pages; and

File attachment encryption and signing.

Specifically, application 22 includes a Crypto Library 300, provided in a manner that is known. In one particular embodiment of the present invention, the application 22 also includes a User Certificate and Private Key Store 302 which contains the cryptographic data required to encrypt and/or digitally sign data included in data communications (including email) contemplated by the present invention. For example, in one particular implementation of the present invention, namely one whereby Entrust™ acts as the Certificate Authority, the .EPF file required to authenticate both the sender and the recipient is downloaded to the network-connected device 10. The .EPF file is an encrypted file which is used to access the user credentials and private key required to process cryptographic operations.

Application 22 of the present invention also includes a PKI browser extension, and specifically an S/MIME browser extension 304. The S/MIME browser extension permits the encryption and decryption of data communications (including email) in a browser, as particularized herein. This has the advantage of broad-based deployment as browser technology is commonplace. This also has the advantage of deployment across wireless and wired networks as the application 22 of the present invention, including the S/MIME browser extension, can be associated with a web browser or a WAP browser, as shown in FIG. 1. In addition, the invention disclosed herein, which requires only a browser and the associated application 22 at each network-connected device 10 S/MIME encrypted communications are possible without the resources usually required to run a full S/MIME encryption program/email reader on the network-connected device 10.

The S/MIME browser extension 304 is provided in a manner known by a skilled programmer. However, it is desirable for the S/MIME browser extension 304 of the present invention to have a number of attributes. First, as a result of the method of the present invention detailed below, it is desirable that the S/MIME browser extension 304 be able to add an attachment to an email message, and also sign and encrypt both the email message and the attachment such that the email message overall is an S/MIME message. Second, the encryption and decryption of data in accordance with the S/MIME standard described herein involves a potential security risk if the S/MIME browser extension 304 is not designed properly. Specifically, it is necessary to ensure that browser memory is utilized in the course of the cryptographic operations such that security is not compromised. In one particular embodiment of the present invention, this is achieved by using the “TEMP” memory space of the browser 20, in a manner known by a skilled programmer. Third, the S/MIME browser extension 304 further includes a CLEANUP ROUTINE in a manner that is known that eliminates any remnants from the memory associated with the browser, or otherwise with the network-connected device 10, of either the message, or the user credential or private key that is part of the User Certificate and Private Key Store 302, in order to maintain confidentiality.

In addition, the present invention contemplates that the S/MIME browser extension 304 facilitates the acceptance of digital certificates issued by an entity not related to the vendor of the application of the present invention, and also that is not “cross-certified”, in a manner that is known. More particularly, the S/MIME browser extension 304 is adapted to permit the user of the application 22 of the present invention to store the digital certificates and public keys of users who are not related to the vendor of the application 22.

Also connected to the Internet 12, is a web server 106 which is provided using known hardware and software utilities so as to enable provisioning of the network-connected device 10, in a manner that is known. The Web server 106 includes a web application 16. The web application 16 is adapted to execute the operations, including PKI operations, referenced below.

Two of the aspects of the present invention include, a system, computer product and method for:

1. Creating and delivering an S/MIME compliant email message to an email server; and

2. Retrieving and deciphering an S/MIME compliant email message from an email server.

In order to achieve the foregoing, the system, computer product and method of the present invention relies on aspects of the Co-Pending Application for engaging in PKI enabled transactions. Specifically, the email messages are created and delivered in accordance with the present invention in a manner that is analogous with the “POSTING DATA ON A SECURE BASIS” described in the Co-Pending Application. An email message is retrieved and deciphered in a manner that is analogous with the “RETRIEVING OF DATA ON A SECURE BASIS” also described in the Co-Pending Patent Application. Regarding the details of the manner in which cryptographic operations are processed by the application 22 of the present invention, reference is made to the Co-Pending Patent Application.

As illustrated in FIG. 1, one aspect of the system of the present invention also includes a known email server 306. The email server 306 sends and receives emails in a manner that is well known. The email server 306 is provided by known hardware and software utilities. Also as illustrated in FIG. 1, one aspect of the system of the present invention includes an email protocol translator 308. The email protocol translator 308 is a known utility which permits the web server 106 and the email server 306 to communicate by translating messages sent by the web server 106 to the particular email protocol understood by the email server 306 such as for example POP3 or IMAP4.

### Creating and Delivering an S/MIME Compliant Email Message to an Email Server

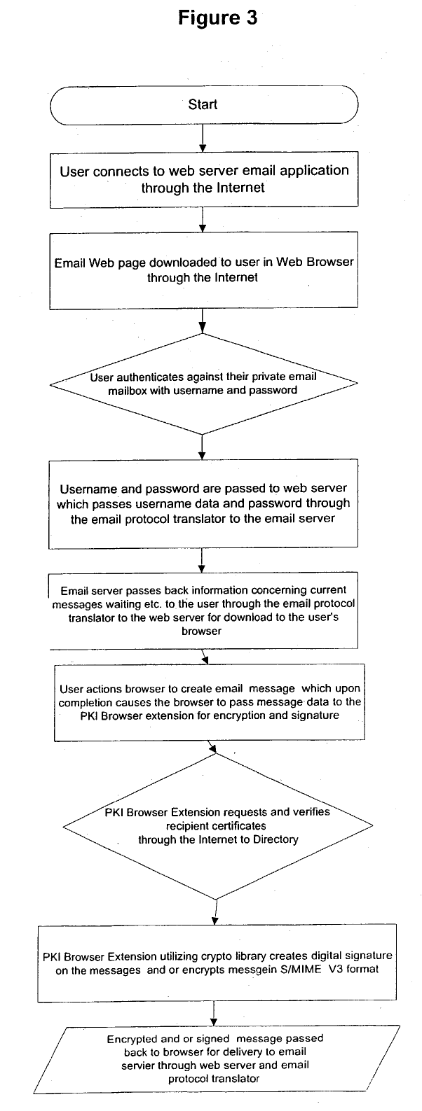

FIG. 3 illustrates the creation and delivery of an S/MIME compliant email message to an email server in accordance with the present invention.

A user associated with a network-connected device 10 who desires to create and send an email on a secure basis (the “Sender”) requests a page on the web server 106 using the browser 20 loaded on the network-connected device 10.

The web server 106, and specifically in co-operation with the web application 16 loaded on the web server 106, responds to the network-connected device 10 by presenting a web page that is a web form requesting that the user associated with the network-device 10 provide authentication in order to gain access to the web application 16, and specifically a web email application (not shown) that is included in the web application 16.

The Sender supplies information in the authentication form fields (such as username and password) on the web page and concludes with submitting the form, typically by pressing a ‘SUBMIT’ button or equivalent.

The authentication credentials are passed to the web server 106. The web server 106 in turn delivers the authentication credentials to the email server 306 via the email protocol translator 308.

Specifically in accordance with the aspect of the present invention whereby the roaming key server 310 is used to access the User Certificate and Private Key Store 302, the web server 106 also transfers the user credentials to the roaming key server 310.

The email server 306 authenticates the Sender and then passes back, through the email protocol translator 308, message waiting lists and other pertinent information about the Sender's email account to the web server 106 for transmission display in the Sender's browser 20 and establishes an email session typically using a cookie, in a manner that is known.

Again, in accordance with the aspect of the present invention utilizing the roaming key server 310, the roaming key server 310 authenticates the Sender and transmits the Sender's private key and certificate through the web server 106 to the S/MIME browser extension 304. In accordance with the aspect of the present invention whereby the User Certificate and Private Key Store resides on the network-connected device 10, the private key and certificate is accessed by the S/MIME browser extension 304.

The Sender prepares an email message by completing the appropriate fields of the web form referred to, including for example the message subject, body and intended recipients fields. In one particular embodiment of the present invention, the application 22 also provides the recipients passwords.

The Certificate Authority 312 is contacted whereby the recipient's public keys and certificates are verified and retrieved from the associated directory 314.

The message form data is passed to the application 22, including the S/MIME browser extension 304, for signing and encrypting the message and any attachments using the private key of the Sender and the public key of the recipients, and also so as to form an S/MIME compliant email message.

The message is returned to the browser 20 and sent from the browser 20 to the web server 106, and using the email protocol translator 308 to the email server 306 for forwarding to the identified recipients.

### Retrieving and Deciphering an S/MIME Compliant Email Message From an Email Server

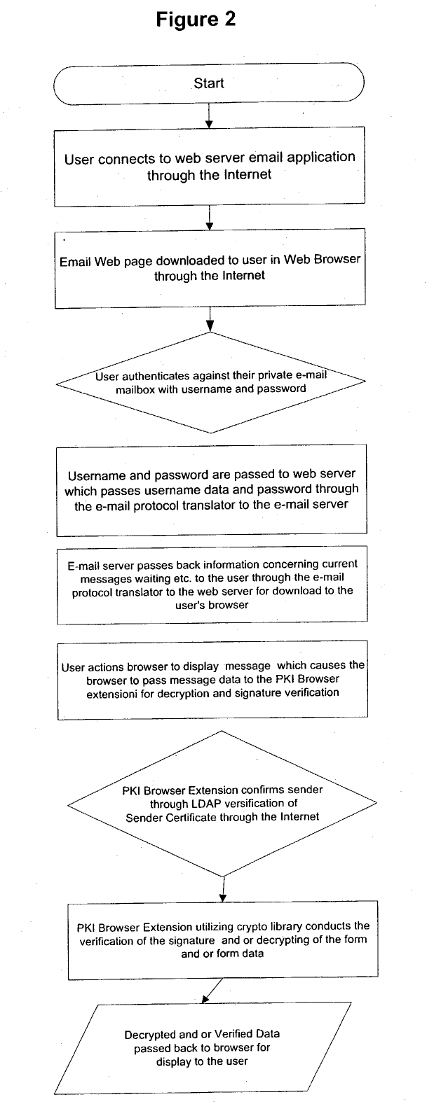

FIG. 2 illustrates the receipt, verification, decryption and display of an S/MIME compliant message from an email server in accordance with the present invention.

A user associated with a network-connected device 10 who desires to display a secure S/MIME compliant that they have received on a secure basis (the “Recipient”) requests a page on the web server 106 using the browser 20 loaded on the network-connected device 10.

The web server 106, and specifically in co-operation with the web application 16 loaded on the web server 106, responds to the network-connected device 10 by presenting a web page that is a web form requesting that the Recipient provide authentication in order to gain access to the web application 16, and specifically a web email application (not shown) that is included in the web application 16.

The Recipient supplies information in the authentication form fields (such as username and password) on the web page and concludes with submitting the form, typically by pressing a ‘SUBMIT’ button or equivalent.

The authentication credentials are passed to the web server 106. The web server 106 in turn delivers the authentication credentials to the email server 306 via the email protocol translator 308.

Specifically in accordance with the aspect of the present invention whereby the roaming key server 310 is used to access the User Certificate and Private Key Store 302, the web server 106 also transfers the user credentials to the roaming key server 310.

The email server 306 authenticates the Recipient and then passes back, through the email protocol translator 308, message waiting lists and other pertinent information about the Recipient's email account to the web server 106 for transmission display in the Recipient's browser 20 and establishes an email session typically using a cookie, in a manner that is known.

The email server authenticates the Recipient and then passes back, through the email protocol translator 308, message waiting lists and other pertinent information about the Recipient's email account to the web server 106 for transmission display in the Recipient's browser 20 and establishes an email session typically using a cookie.

Again, in accordance with the aspect of the present invention utilizing the roaming key server 310, the roaming key server 310 authenticates the Recipient and transmits the Recipient's private key and certificate through the web server 106 to the S/MIME browser extension 304. In accordance with the aspect of the present invention whereby the User Certificate and Private Key Store resides on the network-connected device 10, the private key and certificate is accessed by the S/MIME browser extension 304.

The Recipient requests a message to read which request is sent to the web server 106 through the email protocol translator 308 to the email server 306 with the message request.

The email server 306 retrieves the message and transmits the message to the Recipient through the web server 106 using the email protocol translator 308 to the Recipient's browser 20.

The application 22 authenticates against its User Certificate Private Key Store 302 and thereby the key is released to the S/MIME browser extension 304 component thereof where upon the message signature can be verified and the message decrypted for display in the Recipient's browser 20. Alternatively, in accordance with the aspect of the present invention utilizing the roaming key server 310, the authentication happens against data provided by the roaming key server 310 whereby the message signature can be verified and the message decrypted by the S/MIME browser extension 304.

In another aspect of the present invention, the persistent field level encryption disclosed in the Co-Pending Application is used for the purposes of the present invention to maintain the confidentiality of the identities of users (and for example their clients with whom they communicate on a secure basis in accordance with the present invention) and other personal information, by encrypting related data and storing the data in an encrypted form at a database (not shown) associated with the web server 106.

The system of the present invention is best understood as the overall system including the network connected device 10 and the resources thereof, including the application 22, and also the web server 106 and the email server 306, as well as the resources of these as well. The computer product of the present invention is the application 22 on the one hand, but also the web application 16, on the other. Another aspect of the present invention includes the remote key server 310.

The method of the present invention is best understood as a process for exchanging PKI S/MIME messages through a browser, whether a web browser or WAP browser. The method of the present invention should also be understood as a method for integrating wireless devices with Internet secure messaging using S/MIME. Another aspect of the method of the present invention is a method for delivering private keys and certificates through the Internet or a wireless network. Yet another aspect of the method of the present invention, is a method for eliminating the “man in the middle” security hole of proxy based gateways between the Internet and wireless networks by providing persistent secure data communication using S/MIME. A still other aspect of the present invention is a method for allocating data resources as between the web server and a wireless device such that PKI is provided on the wireless device so as to provide S/MIME encryption on a persistent basis.

The present invention also provides for persistent field level encryption using S/MIME on a selective basis throughout an Internet-based data process. This promotes efficient utilization of resources by invoking PKI operations in relation to specific elements of an Internet-based data process where security/authentication is most needed.

The present invention also provides a set of tools whereby PKI S/MIME capability is added to a browser in an efficient manner.

The present invention should also be understood as a set of tools for complying with legal digital signature requirements, including in association with a wireless device using a web mail system incorporating S/MIME.

A still other aspect of the present invention is a method for permitting secure email messaging between wireless and Internet based or other networks using S/MIME.

We claim:

1. A system for exchanging S/MIME compliant communications electronically comprising:
(a) at least one network-connected device for communicating with one or more remote devices via a communication network, said network-connected device including:
(b) a browser linked to the network-connected device;
(c) an encryption/decryption facility linked to the browser so as to enable PKI transactions to be conducted in the browser; and
(d) an S/MIME facility linked to the browser and the encryption/decryption facility that enables the network-connected device to exchange S/MIME compliant communications with remote network-connected devices via the browser in cooperation with the encryption/decryption facility.

2. A system for exchanging S/MIME communication electronically as claimed in claim 1, wherein the system also comprises:
(a) a key storage means for storing a plurality of keys, each key being useable by an associated user in a public key infrastructure to encrypt and decrypt data; and
(b) a user authentication means for determining whether a prospective user of a key in the plurality of keys is the associated user for the key;
wherein the encryption/decryption facility is linked to the key storage means and the user authentication means such that the encryption/decryption facility encrypts and decrypts data using the plurality of keys when the user authentication means authenticates a user of the network-connected device.

3. A system as claimed in claim 2, wherein the system further comprises an email server, and wherein the encryption/decryption facility and the S/MIME facility enable S/MIME compatible messages to be exchanged between the network-connected device and the email server.

4. A system as claimed in claim 3, wherein the user authentication means communicates with a Certificate Authority to authenticate the prospective user.

5. A system as claimed in claim 4, wherein the user authentication means includes a roaming key server that authenticates the sender of an S/MIME compliant communication and transmits the sender's private key and certificate to the network-connected device via the remote server.

6. A computer product operable on a network-connected device for enabling S/MIME compliant communications between the network-connected device and remote devices via a communication network, the computer product comprising:
(a) a browser;
(b) an encryption/decryption facility linked to the browser so as to enable PKI transactions to be conducted in the browser; and
(c) an S/MIME facility linked to the browser and the encryption/decryption facility that enables the network-connected device to exchange S/MIME compliant communications with the remote device via the browser in cooperation with the encryption/decryption facility.

7. A computer product as claimed in claim 6, the computer product further comprising:
(a) a key storage means for storing a plurality of keys, each key being useable by an associated user in a public key infrastructure to encrypt and decrypt data; and
(b) a user authentication means for determining whether a prospective user of a key in the plurality of keys is the associated user for the key;
wherein the encryption/decryption facility is linked to the key storage means and the user authentication means such that the encryption/decryption facility encrypts and decrypts data using the plurality of keys when the user authentication means authenticates a user of the network-connected device.

8. A computer product as claimed in claim 7, wherein the S/MIME facility is an S/MIME browser extension.

9. A computer product as claimed in claim 8, wherein the S/MIME facility enables encryption and signature of electronic messages and attachments.

10. A computer product as claimed in claim 9, wherein the S/MIME facility is provided such that security of cryptographic operations in the computer product is maintained.

11. A method of sending S/MIME compliant communications electronically comprising:
(a) providing an encryption/decryption facility and an S/MIME facility, linked to a browser, loaded on a network-connected device associated with a sender;
(b) authenticating the sender with a remote server by means of a user authentication means linked to the network-connected device;
(c) the sender requesting an S/MIME compliant communication with a recipient from the remote server;
(d) the remote server communicating the recipient's private key and certificate to the S/MIME facility;
(e) the network-connected device contacting a Certificate Authority to verify the recipient's public key and certificate, by means of the encryption/decryption facility; and
(f) creating an S/MIME compliant communication by signing and encrypting a communication in the browser using the private key of the sender and the public key of the recipient, by means of the encryption/decryption facility and the S/MIME facility.

12. A method of retrieving and deciphering S/MIME compliant communications electronically comprising:
(a) providing an encryption/decryption facility and an S/MIME facility, linked to a browser, loaded on a network-connected device;
(b) requesting the retrieval of an S/MIME compliant communication from the network-connected device;
(c) Authenticating a recipient associated with the network-connected device with a remote server;
(d) The remote server communicating the sender's private key and certificate to the S/MIME facility;
(e) The remote server sending the requested S/MIME compliant communication to the network-connected device;
(f) The encryption/decryption facility authenticating the recipient's private key and certificate against the private key and certificate stored to a key/certificate store accessible from the network-connected device whereby upon authentication thereof the private key and certificate are released to the S/MIME facility, thereby enabling the S/MIME compliant communication to be deciphered in the browser.
